(19) United States
(12) Patent Application Publication
(10) Pub. No.: US 2005/0061644 A1
(43) Pub. Date: Mar. 24, 2005

(54) Switch cabinet

(76) Inventor: Heine Altena, Rijswijk (NL)

Correspondence Address: Patrick W Rasche;Armstrong Teasdale, One Metropolitan Square 2600, St Louis, MO, 63102, US

(21) Appl. No.: 10/489,079

(22) PCT Filed: Sep. 9, 2002
(86) PCT No.: PCT/EP02/10087

(30) Foreign Application Priority Data
Sep. 7, 2001 (DE) 10143918.0

(51) Int. Cl. H01J 1/00

(52) U.S. Cl. 200/237

(57) ABSTRACT

A switch cabinet includes at least two horizontally extending frame profiles having a sealing edge, a fastening surface, and two side walls. Each of the side walls includes a one-part sheet metal blank which forms a frame-like profile edge on all four sides by means of multiple canting, the profile edge being adapted to the frame profile and provided with rows of holes, and the adjacent profile edges ending before the respective edge of the side wall, leaving open a receiving portion for the fastening member of the frame profile.

### CROSS REFERENCE TO RELATED APPLICATIONS

This application is a filing under 35 U.S.C. 371 of PCT/EP 02/10087 which was filed Sep. 9, 2002, which claims the benefit of German Application No. 101 43 918.0 filed Sep. 7, 2001.

### BACKGROUND OF THE INVENTION

The present invention relates to a switch cabinet including at least two horizontally extending frame profiles having a sealing edge and fastening holes, and two side walls.

Switch cabinets of this type are known in the prior art and offer very different possibilities of fastening the side walls. For instance, switch cabinets are known that comprise a frame structure to which the side walls can be fastened. Equally, switch cabinets are also known, wherein the vertical edges of the side walls already assume the function of the vertical side profiles of the frame structure, i.e. they are already provided with profile holes to which further board elements can be fastened. The last-mentioned switch cabinets often have the drawback of a transition between side wall and bottom and/or ceiling area because additional profile portions have to be welded to the side wall to this end. The weld points, however, require considerable extra work during production on the one hand and constitute a weak point of the switch cabinet on the other hand. Furthermore, it is most of the time necessary to weld the side walls to one another despite a profiled contour to ensure an adequate stability of the switch cabinet. Moreover, additional mounting possibilities, the installation of which is complicated, are often desired in the interior of the switch cabinets.

It is therefore the object of the present invention to simplify the structure of a switch cabinet of the above-mentioned type as much as possible and to provide additional fastening points in the interior of the switch cabinet at the same time.

### BRIEF DESCRIPTION OF THE INVENTION

Said object is achieved for a switch cabinet of the known type in that the side walls each comprise a one-part sheet metal which forms a frame-like profile edge on all four sides by means of multiple canting, the profile edge being adapted to the frame profile and provided with rows of holes, and the adjacent profile edges ending before the respective edge of the side wall, leaving open a receiving portion for a fastening member for the frame profile.

With such a design of the switch cabinet, profile edges that, in cooperation with the frame profiles, can easily be connected to obtain the switch cabinet are provided on all edge portions of the side wall. A universal installation is here ensured by the provision of rows of holes.

Since the profile edges are provided on all of the four sides, it is possible to enhance the stability of the resulting switch cabinet. No additional connection measures, such as welding, are needed, so that production can be simplified and costs can be saved.

Advantageously, the frame-like edge profiles in the installed state are oriented towards the interior of the switch cabinet. The assembly is thereby displaced into the interior, so that no objectionable edges are found on the outside. At the same time, the edge profiles are available for the internal mounting of further components.

According to a preferred embodiment, the frame-like edge formed on the four sides of the side wall may respectively be designed as an open profile. Such an open profile provides, on the one hand, adequate stability of the profile edges canted in this way and offers, on the other hand, the possibility of additionally using the resulting open portion, e.g. for guiding cables or the like, without any impairment of mounting units arranged in the interior of the switch cabinet.

Advantageously, the vertical sides of the side wall have identical profile edges that are side-inverted. This ensures uniformity of the switch cabinet to be built up.

According to another embodiment the vertical profile edges of the side wall may have substantially four successive sections, the first section being canted vertically towards the interior of the switch cabinet, the second section being canted from the first section to the outside, the third section being canted from the second section inwards in parallel with the side wall, and the fourth section being canted from the third section vertically towards the side wall.

It is possible through the indicated canting sequence to obtain an open profile edge which shows adequate stability for a switch cabinet. At the same time, an outwardly oriented sealing edge, which is e.g. of advantage upon abutment of a door, is provided between the second and third section.

The second section may here be angled relative to the first section at an angle of more than 90°. The third section may have an angle of about 30° relative to the second section. The indicated angles have turned out to be particularly preferred in practice to provide a sealing edge between the second and third section and to ensure the necessary stability.

It may be of advantage when the width of the third section is substantially identical with the joint widths of the first and second sections. When the third section is made relatively broad in comparison with the first and second sections, this provides, on the one hand, a broad contact surface in the interior of the switch room, e.g. for mounting inner components; on the other hand, part of said contact surface can be used for designing the frame of the switch cabinet.

Advantageously, the rows of holes of the vertical profile edges of the side wall may be formed in the third section. In this instance, two rows of holes may be arranged in parallel with one another. Since the third section is designed as the contact surface facing the interior of the switch cabinet, the rows of holes provided in said contact surface ensure universal installation possibilities for the interior of the switch cabinet. Since two rows of holes that extend in parallel with one another are provided, the possibilities of installation are multiplied and can freely be designed by the final consumer, depending on the application. Furthermore, the rows of holes are also particularly easily accessible in the mounted state of the switch cabinet.

According to a further embodiment of the invention, the profile edge of the horizontal side of the side wall, which horizontal side is the top one in the installed state, may comprise four successive legs that are canted towards the interior of the switch cabinet such that the first leg extends beyond the side wall towards the interior of the switch cabinet, the second leg is canted from the first leg and arranged in a direction perpendicular to the side wall, the third leg extends from the second leg vertically downwards and in parallel with the side wall, and the fourth leg is canted towards the side wall vertically from the third leg.

This canting sequence, too, ensures an open profile again that can be used e.g. for fixing cables, or the like. It has been found to be useful when the angle formed between the side wall and the first leg and between the first and second legs is larger than 90°.

This feature further ensures that the open space formed between the individual legs is sufficiently large to be used further. At the same time, an adequate stability of the profile edge is also ensured.

Advantageously, the width of the third leg can be chosen to be larger than that of the remaining legs. Since the third leg extends in parallel with the side wall, this provides a contact surface for the interior of the switch cabinet again, so that an adequate surface is provided for further assembly by way of the width chosen.

It has turned out to be useful when the row of holes is formed in the third leg. Furthermore, two rows of holes that extend in parallel with one another may be formed in the third leg.

This feature increases the universal installation of the side wall again. At the same time, an easy accessibility of the rows of holes is ensured.

Advantageously, the first leg can extend over the spared receiving portion for the fastening member up to the edge of the side wall. Since the first leg extends beyond the receiving portion, protection is provided for the fastening member because this member is not readily accessible from the outside.

According to a further embodiment the profile edge of the horizontal side, which is the bottom one in the installed state, may have three successive fold surfaces that are canted towards the interior such that the first fold surface is canted vertically towards the side wall into the interior of the switch cabinet, the second fold surface extends vertically from the first fold surface upwards, and the third fold surface extends vertically from the second fold surface in parallel with the first fold surface to the side wall.

Advantageously, the width of the first fold surface may be a multiple of the widths of the second and third fold surfaces.

The design of the first fold surface as a particularly broad surface has turned out to be particularly advantageous in practice because said first fold surface simultaneously represents the support surface of the side wall. This feature, in turn, enhances the overall stability of the switch cabinet.

According to a preferred embodiment the third fold surface may be provided with the row of holes. Since the third fold surface is directed upwards into the interior of the switch cabinet, this offers the possibility of arranging a bottom plate inside the switch cabinet in a simple way.

Advantageously, the individual holes of the row of holes may be made round and/or cornered and arranged at regular intervals relative to one another. This design permits a very universal use of the side wall and can be used by the final consumers without any troublesome reworking. Thanks to the standardized distance, elements from other manufacturers can also be connected with the rows of holes provided for.

It has turned out to be particularly advantageous when the third section of the vertical sides of the side wall is formed with a row of holes which is directed towards the outside of the switch board and composed of round holes, and with a row of holes which extends in parallel therewith and which is arranged towards the interior of the switch cabinet and composed of alternatingly round and cornered holes. This additional row of round holes turns out to be useful particularly when paint is applied to the side wall because a complete application to the inside of the side wall can thereby be ensured.

The side wall of the switch cabinet of the invention that is provided with profile edges can be formed easily with a few cants only. The rows of holes provided in the profile edges permit a universal use of the side wall, so that these can be used in a user-specific way.

According to a further embodiment the legs of the horizontal frame profiles and the third section of the profile edge of the side wall, which third section is arranged in the installed state in a direction perpendicular to said legs, may be designed with an identical hole profile at the side facing the interior of the switch cabinet. A contact surface extending beyond the whole frame portion is thereby provided with the same hole profile, thereby facilitating the fastening of further components in the interior of the switch cabinet. In cooperation with the row of holes provided on the third fold surface, the fastening possibilities are even considerably increased.

Advantageously, the sheet metal forming the side wall has a thickness of 1.5 mm. This sheet thickness has turned out to be adequate in practice with respect to the requirements made on the side wall, for instance with respect to stability and workability.

### BRIEF DESCRIPTION OF THE DRAWINGS

The invention will now be explained in more detail with reference to an exemplary embodiment taken in conjunction with the drawings, in which:

FIG. 1 is a sectional perspective view of a side wall of a switch cabinet according to the invention, the side wall being provided with vertical profile edges;

FIG. 2 is a sectional perspective view of a switch cabinet according to the invention, showing an upper frame profile and a cutout of an adjoining side wall;

FIG. 3 is a sectional perspective view of a switch cabinet according to the invention, showing a lower frame profile and an adjoining side wall; and

FIG. 4 is schematic view of the necessary canting processes.

### DETAILED DESCRIPTION OF THE INVENTION

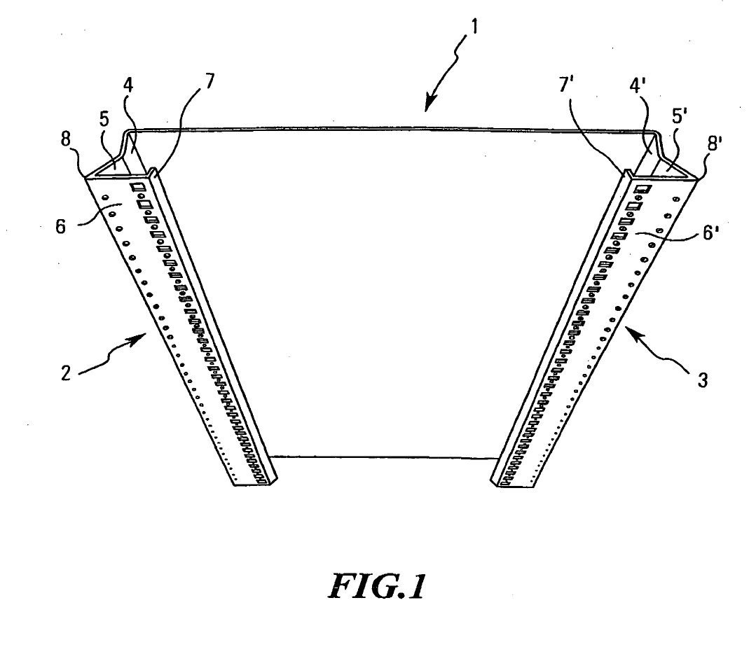

FIG. 1 shows a portion of an exemplary switch cabinet having a side wall 1 which is formed on both vertical sides with profile edges 2 and 3. It should be noted that only part of the side wall 1 is shown and that the side wall according to the invention is also provided with profile edges at the upper and lower side.

The two profile edges 2 and 3 are of an identical, but side-inverted, configuration. Each profile edge 2, 3 is formed by multiple canting of the side wall 1.

In detail, each of the vertical profile edges 2, 3 comprises four sections created by successive bending. First of all, a first section 4,4′ is bent from the side wall 1 vertically towards the interior of the switch cabinet. Subsequently, a second section 5,5′ is canted from the first section, said second section extending outwards away from the side wall 1. An angle of more than 90°, preferably 100°, is here formed between the first section 4,4′ and the second section 5,5′. Subsequently, starting from the second section 5,5′, the third section 6,6′ is bent, section 6,6′, in turn, being canted towards side wall 1 and extending in parallel with side wall 1. Subsequently, starting from the third section 6,6′, the fourth section 7,7′ is canted, the sections 6,6′ and 7,7′ extending in a direction perpendicular to one another, and section 7,7′ extending towards the side wall 1. As a consequence, sections 4,4′ and 7,7′ extend in parallel with one another. The outermost lateral point is respectively provided by the fold edge 8,8′ formed between the second section 5,5′ and the third section 6,6′. The edge 8,8′ simultaneously serves as a sealing edge in the installed state.

In an alternative embodiment to FIG. 1, the individual edges 2, 3 do not have to be bent as sharply. For example, a 45°-area may here also be formed on the respective fold or bend edge 8, 8′.

In the installed state, the third section 6, 6′ serves as a contact surface which is directed into the interior of the switch cabinet and to which further elements can be fastened. To this end, two rows of holes that are arranged in parallel with one another are formed in the third section 6,6′. The first row of holes facing away from the interior of switch cabinet has round holes arranged at regular intervals relative to one another, and the second row of holes facing the interior of the switch cabinet is composed of round and rectangular holes which are arranged in alternating fashion and at regular intervals with respect to one another. The provision of different holes makes it possible to fasten very different elements.

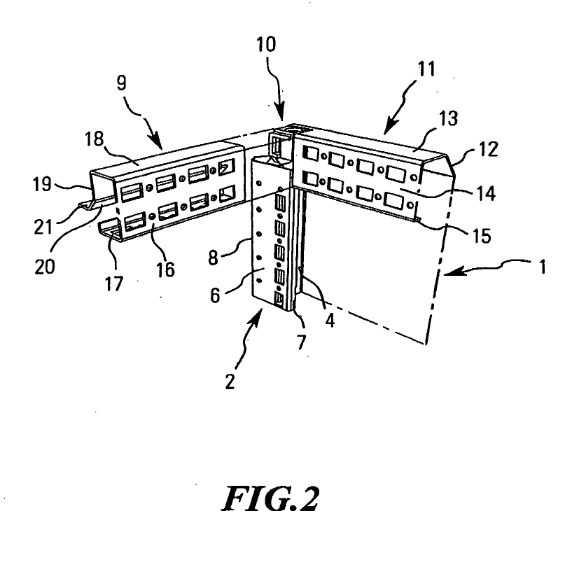

The embodiment shown in FIG. 2 is a sectional perspective illustration of a switch cabinet according to the invention, the figure showing a cutout of a side wall 1 with a vertical profile edge 2, and an upper horizontal profile edge 11. Also shown is an upper horizontal frame profile 9 before mounting on the side wall 1, and a fastening member 10 already connected to the side wall 1.

The vertical profile edge 2 of the side wall 1 corresponds to the one already described with reference to FIG. 1. An important feature of the vertical profile edge 2, which is not shown in FIG. 1, is that said edge 2 does not extend over the whole side of side wall 1, but that an upper portion, adjoining the upper horizontal edge, is left open or spared, i.e., it has no profile edge. It should here be noted that the second vertical profile edge 3 (shown in FIG. 1) is of an identical, but side-inverted, configuration.

FIG. 2 also shows the upper profile edge 11 of the side wall 1, as has already been mentioned. The upper profile edge 11 is also formed by canting a portion of the side wall.

In detail, four legs 12 to 15 are formed by canting. These are arranged relative to one another as follows. Starting from the side wall 1, a first leg 12 is folded, facing the interior of the switch cabinet, whereby an angle of more than 90° is formed. Starting from the first leg 12, a second leg 13 is formed by canting, said second leg 13) extending in a direction perpendicular to the side wall I and being inclined towards the interior of the switch cabinet. Subsequently, the third leg 14 is formed by vertical canting, the third leg 14 extending in parallel with the side wall 1 and downwards, i.e., oriented towards the lower horizontal edge of the side wall 1. The fourth leg 15 is formed by renewed vertical canting, said leg 15 being directed towards side wall 1.

The first leg 12 and the second leg 13 have about the same size, whereas the third leg 14 is made much broader. In the installed state, this third leg 14 serves as an inner contact surface. To this end, rows of holes are also provided in the third leg 14, preferably two rows of holes extending in parallel with one another, each row having both round and rectangular holes which are arranged in alternating fashion and at regular intervals relative to one another.

The upper horizontal profile edge 11 does not extend over the whole surface of the side wall, but also leaves a portion open at each end. However, only the portion formed by the second leg 13, the third leg 14 and the fourth leg 15 is spared, whereas the first leg 12 extends over the whole width of the side wall 1.

The two contact surfaces of the profile edges 2 and 11, namely the section 6 and the leg 14, extend in one plane relative to one another. A contact surface formed by three sides of side wall 1 and comprising rows of holes is thereby provided. Further components of the switch cabinet can easily be mounted on said contact surfaces.

An upper horizontal profile frame 9 is connected to the side wall 1 in the assembled state. For this purpose, a fastening member 10 is inserted into the vertical profile edge 2 and extends up to the second leg 13. It becomes apparent that the first leg 12 that extends over the whole side wall simultaneously protects the fastening member 10 on the outside.

The upper horizontal frame profile 9 has a broad abutment surface 16 oriented towards the interior of the switch cabinet, which in the installed state is arranged perpendicular to the third leg 14 relative to side wall 1. The widths of the third leg 14 and of the abutment surface 16 are here approximately the same. Like the third leg 14, the abutment surface 16 is provided with two rows of holes extending in parallel with one another, round holes and rectangular holes alternating with one another. Starting from the upper and lower edge of the abutment surface 16, two legs 17 and 18, which are in parallel with one another, are extending, each facing away from the interior of the switch cabinet vertically from the abutment surface 16. The two legs 17 and 18 have about the same width, but leg 17 is additionally provided with a row of holes, whereas leg 18 has no holes. Subsequently, the leg 17 passes into a canted portion which extends substantially vertically from the leg 17 towards the leg 18.

A leg 19 which has about the same dimensions as leg 18 is arranged at a right angle relative to leg 18 and in parallel with the abutment surface 16. A leg 21 is arranged at a right angle relative to leg 19, legs 19 and 21 being interconnected via a leg 20 formed by the angle bisector.

The horizontal profile 9 is also an open profile but, unlike the edge profiles 2, 3 of the side wall 1, it is not accessible from the interior of the switch cabinet, but rather from the outside.

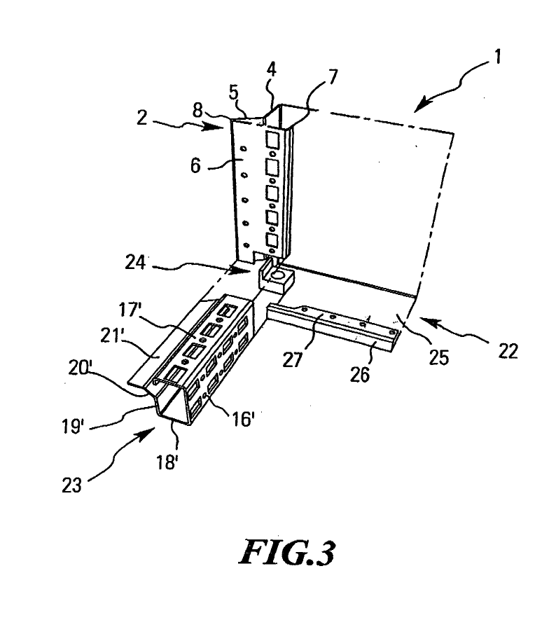

The cutout of an inventive switch cabinet as illustrated in FIG. 3 shows a lower corner of the switch cabinet, including the side wall 1 with the already described vertical side edge 2 and a lower horizontal profile edge 22. Furthermore, a lower horizontal frame profile 23 is shown that can be connected by means of a fastening member 24 to the side wall 1.

The lower edge profile 22 of the side wall 1 is formed by three fold surfaces 25, 26, and 27 that are successively canted from the side wall. First of all, the fold edge 25 is canted at a right angle from the side wall 1. The fold surface 25 is here made relatively broad because, when used, it forms a bottom support surface so that the broad design thereof imparts additional stability to the switch cabinet.

The fold surface 26 extends at a right angle relative to the fold surface 25, the fold surface 26 being made relatively small. From the fold surface 26 and parallel to the fold surface 25, the fold surface 27 is angled at a right angle towards the side wall 1. A row of holes which is composed of round holes is provided in said fold surface 27.

The edge profile 22, in turn, does not extend over the whole surface of the side wall 1, but the respective corner portions are again spared for joining the side wall 1 with the frame profile 23. A fastening member 24 may here be provided for the joining operation.

The lower frame profile 23 corresponds to the upper frame profile 9, the frame profile 23 being side-inverted, i.e. the leg 17′ extends into the interior of the switch cabinet. The lower frame profile 23 is also accessible from the outside of the switch cabinet.

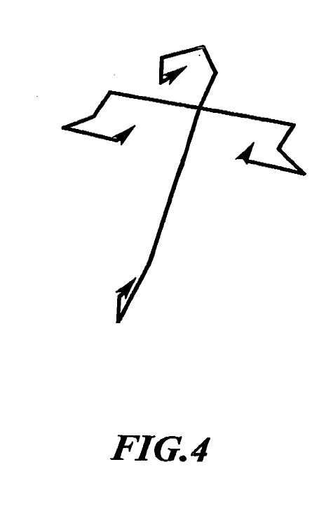

As has already been stated, the edge profiles 2, 3, 11 and 22 of the side wall 1 are made integral with the side wall 1, a one-part sheet metal blank being here started from that has been given the above-described form by multiple canting. FIG. 4 roughly shows the individual canting processes of each side in a schematic way.

Thanks to the additional rows of holes the side wall 1 offers adequate fastening possibilities in the interior of the switch cabinet, said rows of holes being easily accessible. Furthermore, the profile edges 2, 3, 11, and 22, which are formed as open profiles, make it possible to stow away further components, e.g. to fix cables in the profile edges.

While the invention has been described in terms of various specific embodiments, those skilled in the art will recognize that the invention can be practiced with modification within the spirit and scope of the claims.

1. A switch cabinet comprising.
at least two horizontally extending frame profiles having a sealing edge and fastening holes; and
two side walls, each of the side walls comprising a one-part sheet metal blank having four side edges with opposite ends, each side edge defining a frame-like profile edge by means of multiple canting, the profile edge being adapted to said frame profile and provided with rows of holes, and the profile edge ending before the respective ends of the respective side edge of said side wall, thereby leaving open a receiving portion for a fastening member for the frame profile;
wherein at least three different profile edges are formed on said side walls.

2. The switch cabinet according to claim 1, wherein said frame-like profile edges is oriented toward an interior of the switch cabinet in an installed state.

3. The switch cabinet according to claim 1, wherein said frame-like profile edge formed as an open profile.

4. The switch cabinet according claim 1, wherein vertical sides of the side wall include substantially identical profile edges designed in side-inverted fashion with respect to one another.

5. The switch cabinet according to claim 4, said vertical profile edges comprising first, second, third and fourth successive sections, said first section being canted in a direction perpendicular to the interior of the switch cabinet, said second section being canted outwards from said first section, said third section being canted from said second section inwards in a direction parallel to said side wall, and said fourth section being canted from said third section in a direction perpendicular to said side wall.

6. The switch cabinet according claim 1, at least one of said profile edges of said side wall comprising first and second successive sections, wherein said second section is angled relative to said first section at an angle of more than 90°.

7. The switch cabinet according claim 1, at least one of said profile edges of said side wall comprising first, second, and third successive sections, wherein said third section has an angle of about 30° relative to said second section.

8. The switch cabinet according claim 1, at least one of said profile edges of said side wall comprising first, second, and third successive sections, and a width of said third section is substantially identical with a joint width of said first and second section.

9. The switch cabinet according claim 4, wherein said rows of holes of said vertical profile edges of said side wall are formed in said third section.

10. The switch cabinet according to claim 9, wherein said rows of holes comprises two rows of holes arranged in parallel with one another.

11. The switch cabinet according to any one of claim 1, wherein a profile edge of a horizontal side edge, which is a top edge one in an installed state, of the side wall comprises four successive legs canted relative to an interior of the switch cabinet such that the first leg extends beyond said side wall (1) towards the interior of the switch cabinet, said second leg is canted from said first leg and arranged perpendicular to said side wall, said third leg extends from said second leg vertically downwards and substantially parallel to said side wall, and said fourth leg is canted towards said side wall vertically from the third leg.

12. The switch cabinet according to claim 11, wherein angles formed between said side wall and said first leg and between said first and said second leg are made larger than 90°.

13. The switch cabinet according to claim 11, wherein a width of said third leg is larger than a width of said first, second or fourth legs.

14. The switch cabinet according claim 11, wherein said rows of holes are formed in said third leg.

15. The switch cabinet according to claim 11, wherein said rows of holes comprises two rows of holes extending in parallel with one another, said two roles of holes formed in said third leg.

16. The switch cabinet according to claim 11, wherein said first leg extends over said receiving portion for a fastening member.

17. The switch cabinet according claim 1, wherein a profile edge of a horizontal side, which is a bottom edge in an installed state, of the side wall comprises three successive fold surfaces that are canted towards an interior of the switch cabinet such that the first fold surface is canted in a direction perpendicular to the side wall into the interior of the switch cabinet, the second fold surface extends vertically from the first fold surface upwards, and the third fold surface extends from the second fold surface in a direction parallel to the first fold surface.

18. The switch cabinet according to claim 17, wherein a width of the first fold surface is a multiple of the widths of the second and third fold surfaces.

19. The switch cabinet according to claim 17, wherein said third fold surface is provided with the row of holes.

20. The switch cabinet according to claim 1, wherein individual holes of the rows of holes are made round and/or cornered and are arranged at regular intervals relative to one another.

21. The switch cabinet according to claim 4, wherein said third section of the vertical side edges of the side wall is formed with a row of holes which is oriented to the outside of the switch cabinet and composed of round holes, and with a row of holes which extends in parallel therewith and is arranged towards the interior of the switch cabinet and is composed of alternatingly round and cornered holes.

22. The switch cabinet according to claim 20, wherein legs of a horizontal frame profiles and a section of a vertical profile edge of the side wall when in an installed state is arranged in a direction perpendicular thereto, are provided with an identical hole profile at the side facing an interior of the switch cabinet.

23. The switch cabinet according to claim 1, wherein said sheet metal forming the side wall has a thickness of approximately 1.5 mm.
